(19) United States
(12) Patent Application Publication
(10) Pub. No.: US 2010/0205176 A1
(43) Pub. Date: Aug. 12, 2010

(54) Discovering City Landmarks from Online Journals

(75) Inventors: Rongrong Ji, Harbin (CN); Xing Xie, Beijing (CN); Wei-Ying Ma, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/370,270

(22) Filed: Feb. 12, 2009

(51) Int. Cl. G06F 17/30

(52) U.S. Cl. 707/737; 707/E17.007

(57) ABSTRACT

A blog-based city landmark discovery framework is described to discover and summarize popular scenes and their representative views from blog photos to provide online personalized tourist suggestions. First, a location extraction algorithm is implemented to infer geographical associations of blog photos from their contextual descriptors, thus providing the ability to harvest city scene photos from web blogs. Second, a visual-textual hierarchical clustering scheme is adopted to organize crawled photos into a scene-view structure, and present a PhotoRank algorithm to discover representative views within each scene by viewing the representative photo selection problem as a popularity ranking problem in a visual correlation environment. Third, author, context and content issues are evaluated in a unified Landmark-HITS model to discover representative scenes as well as build author correlations. The author correlations further facilitate a collaborative filtering process for online personalized tourist suggestions based on an author's previous travel logs.

### BACKGROUND

Community-contributed multimedia is greatly impacting both the Internet or web structure and the daily lives of millions of people. The community character provided by this new Internet structure brings novel challenges as well as great opportunities to traditional multimedia analysis methodology. Current state-of-the-art methodologies address content understanding and community analysis in a loosely coupled manner, which prevents extracting deep insight from such data. A need exists for integrating community analysis and multimedia understanding for community-based multimedia knowledge extraction.

The Internet is the largest platform for sharing human knowledge, building social communities, and displaying the daily lives of individual people on a world-wide scope. Facebook® and MySpace® are examples of social web communities that are increasingly impacting human activities. Meanwhile, the past two decades have also witnessed far-reaching evolutions of web communities. Web communities can share increasingly rich content, including multimedia, which forms a growing fraction of community resources. Many web communities feature geographical tags, and offer functions such as traffic suggestions and restaurant recommendations.

With the advances in multimedia understanding and community analysis, exploiting community multimedia for knowledge extraction has great potential. On-the-fly accessibility to volumes of such data, together with the communal nature of such data, provides great opportunities to improve the performances of traditional multimedia content understanding techniques. Such capabilities also provide further opportunities to conquer the semantic gap by integrating user-contributed knowledge. However, traditional multimedia understanding schemes do not exploit the connections between the community nature, context information and multimedia character among various sites on the web. Integration between multimedia understanding and community analysis has received little consideration in methodology designs. The same situations exist in methods that are mainly based on community cues in community-based multimedia data analysis. As a result, existing frameworks face great difficulties in discovering valuable knowledge from community-based media.

To make better sense of such data, the consideration of the community nature and multimedia character should be integrated in a tightly coupled manner in methodology design. The content and context cues of the community multimedia should be seamlessly fused with a community's geographical and social cues to uncover the real nature of community-contributed multimedia.

### SUMMARY

The method presented herein enables a fusion of data from geography, content, and community aspects to reinforce each other. First, a location extraction algorithm is implemented to infer geographical associations of blog photos from their contextual descriptors, thus providing the ability to harvest city scene photos from web blogs. Second, a visual-textual hierarchical clustering scheme is adopted to organize crawled photos into a scene-view structure. A PhotoRank algorithm is then used to discover representative views within each scene by viewing the representative photo selection problem as a popularity ranking problem in a visual correlation environment. Third, author, context and content issues are evaluated in a unified landmark-HITS model to discover representative scenes as well as build author correlations. The author correlations further facilitate a collaborative filtering process for online personalized tourist suggestions based on an author's previous travel logs.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

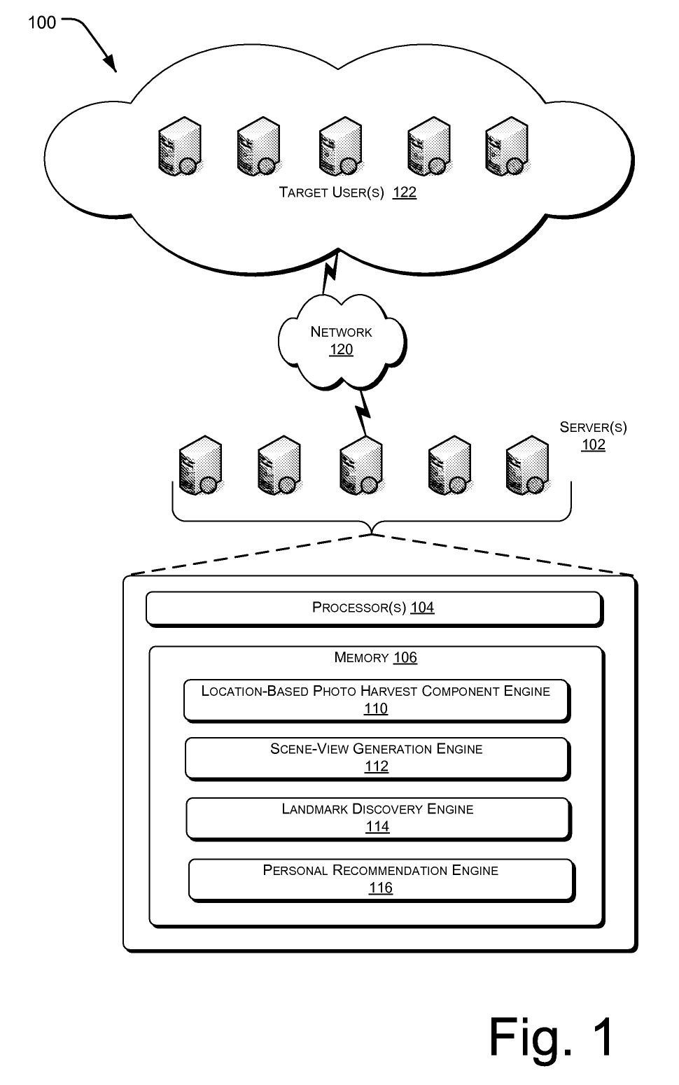

FIG. 1 depicts an illustrative architecture that implements a process for discovering city landmarks from online journals.

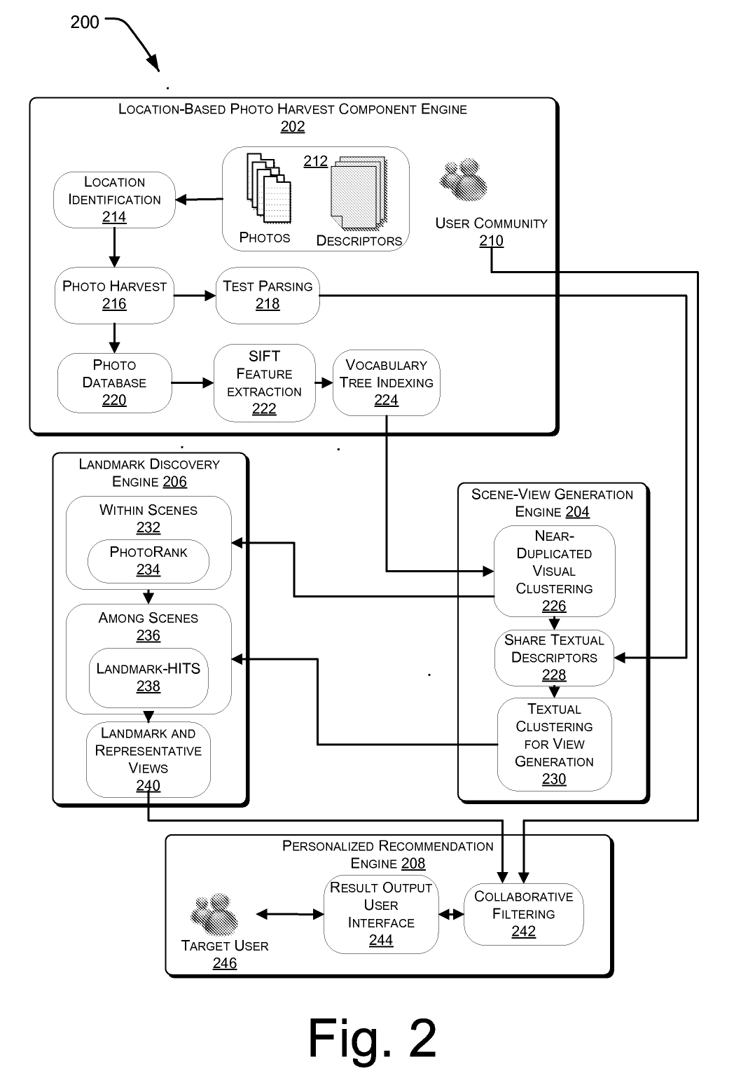

FIG. 2 depicts illustrative components of FIG. 1 for discovering city landmarks from online journals.

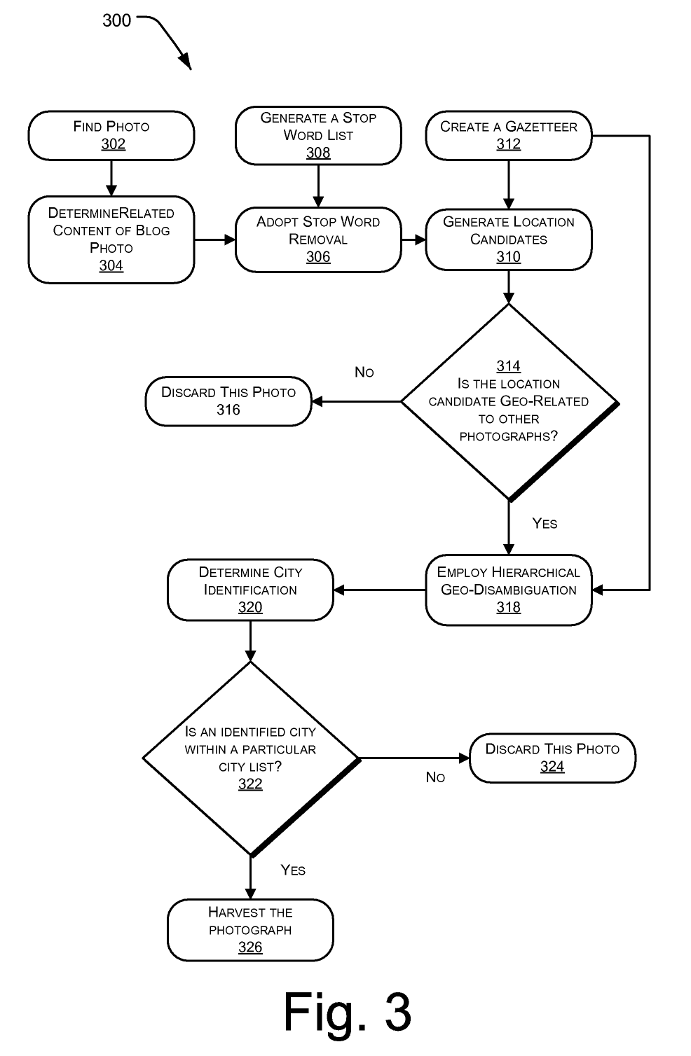

FIG. 3 depicts an illustrative process for extracting the location photographs in the location-based photo harvest component engine of FIGS. 1 and 2.

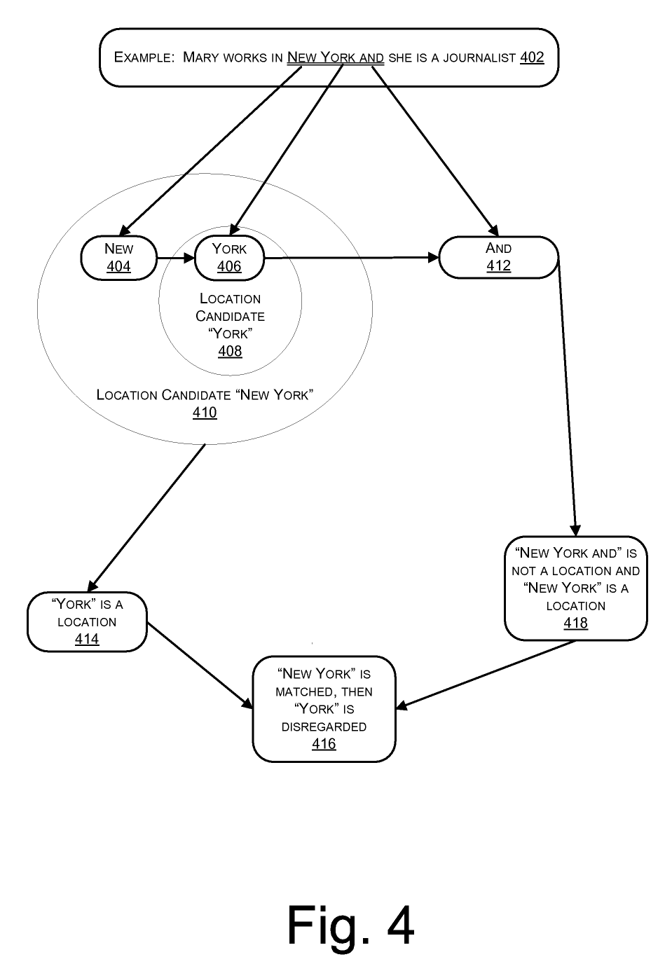

FIG. 4 depicts an illustrative process for implementing a longest match principle by a location-based photo harvest component engine of FIGS. 1 and 2.

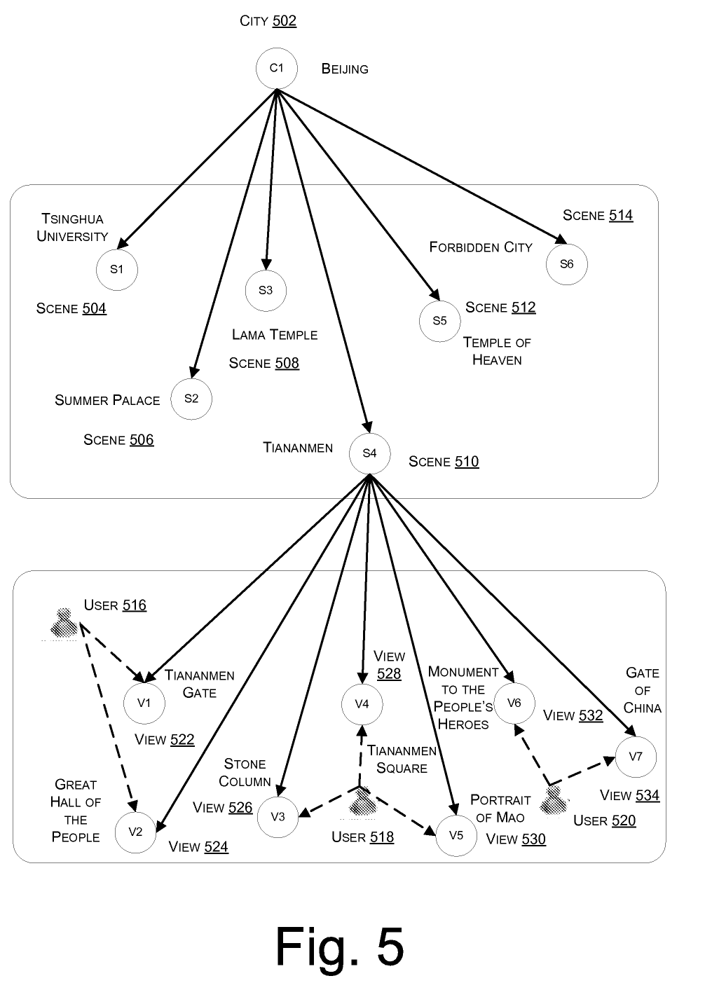

FIG. 5 depicts how a scene view generation engine from the architecture of FIGS. 1 and 2 may determine scenes and views from user journals.

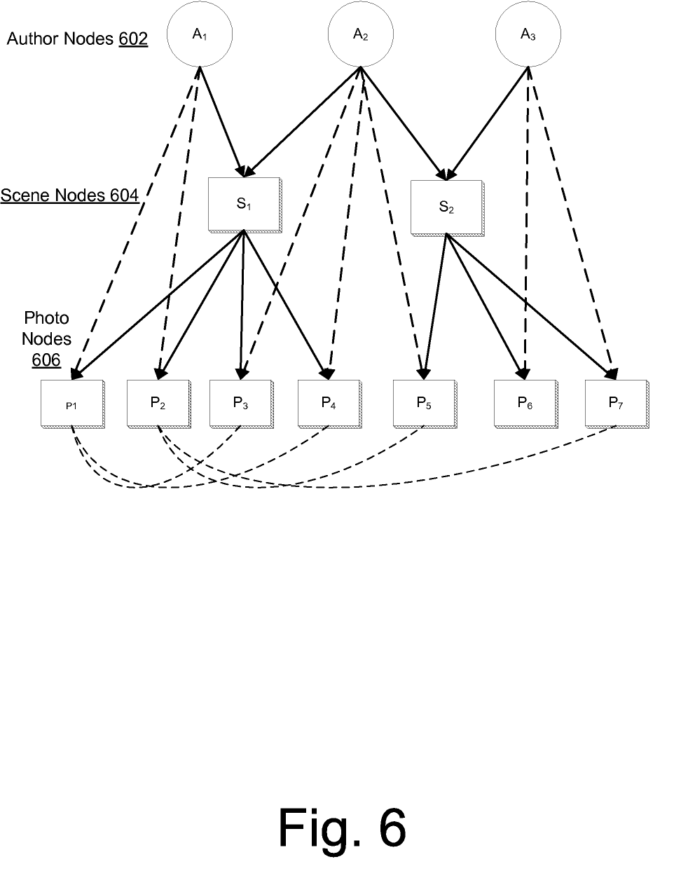

FIG. 6 depicts how a landmark discovery engine from the architecture of FIGS. 1 and 2 may may structuralize photo datasets by organizing photographs into a scene-view structure.

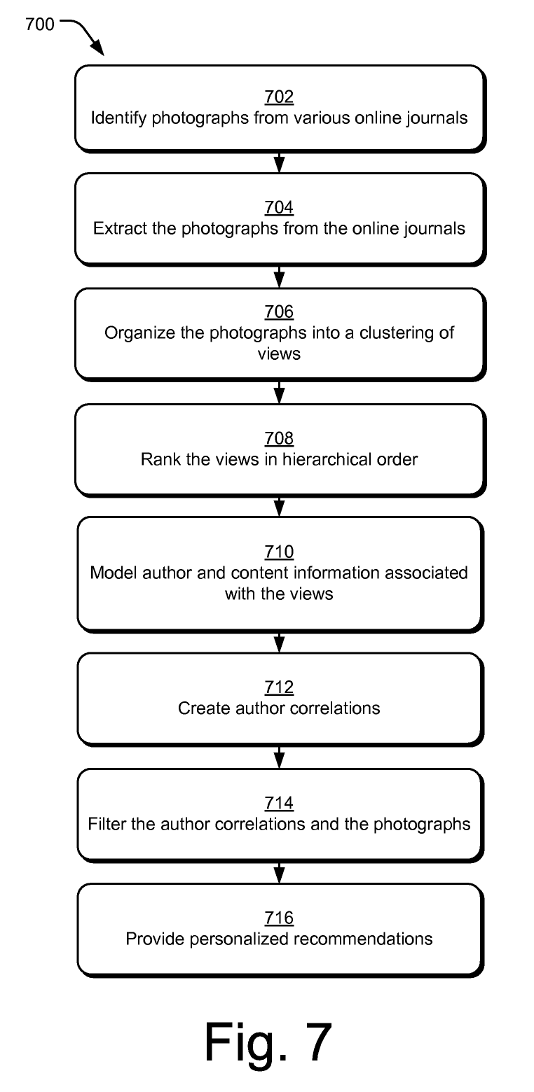

FIG. 7 depicts an illustrative process for discovering city landmarks from online journals.

### DETAILED DESCRIPTION

### Overview

The following discussion describes techniques for exploiting user-published content (e.g., online journals such as: web blogs, web pages, social networking profiles, or the like) to discover city landmarks and to create personalized recommendations. With use of online journals such as blogs, people record their daily lives, build their social relationships, and share interests such as photos, articles, and video clips with friends. From the context and content perspectives, scene photos in web blogs are usually taken with high-resolution cameras and are tagged with context descriptors. The context descriptors may indicate the geographical location of the scenes among other things. Blog photos result from the contributions of blog users and usually include large volume files, high quality photographs, and detailed descriptions of the photographs. Correlations of visited locations among users may indicate similarities in their travel interests.

The structure of blog photographs and the variability of the context descriptors and blog data present unique challenges in developing a method to identify photographs and other representative scenes and content and provide personalized recommendations based on this discovery. The personalized recommendations use the context descriptors and blog photographs to make suggestions or recommendations to target users based correlations between the target users' past postings to blogs and other websites and searches on the web and posts by other authors or users who have posted similar information. For instance, the personalized recommendation may suggest certain cities and landmarks that the target user may want to visit. The use of the architecture described herein may also be used for many other similar types of data in addition to cities and landmarks. It could also be used for restaurants the target user may wish to visit or any other type of multimedia interpretation in a community based environment. The primary challenges are location detection, data scale and notice, exploiting community knowledge and developing a user similarity measurement.

Location detection identifies the geographical location or geo-location of blog photos from their related blog contexts. The ambiguities of geo-location names (e.g. Washington for either Washington D.C. or Washington State) are especially problematic in geographic location identification. Location extraction techniques are more fully described in U.S. patent application Ser. No. 11/081,014 which is incorporated by reference.

Data scale and noise issues may be problematic due to the large volume of blog-based multimedia and the associated demands on an efficient landmark discovery algorithm. The web also introduces data noise to blog photos, which creates additional challenges to landmark discovery accuracy. A landmark represents a famous scene in a city, such as the Louvre Museum, the Arc de Triomphe and the Eiffel Tower. The landmark discovery component provides a summary of city scenes and highlights city landmarks and their representative views from a city photo set.

The community nature of a blog provides key evidence for landmark discovery. For instance, blog authors who take many high-quality scene photos are more likely to contribute representative landmark photos. In addition, authors that take visually similar photos may share related contextual descriptors. The community consensus, based on the preferences of the majority of users, includes both popular scenes and representative views of those popular scenes. Therefore, photo associations are used to make photo popularity inferences.

The definition of the similarity between two users for personalized recommendations is also a challenge. The tourist similarity is a hierarchical definition where user experiences differ from one another. The blogs of users visiting the same cities, scenes, and views may include different aspects of similarity related to the cities, scenes and views visited by the same blog users.

In response to the blog data and the challenges involved, a blog-based personalized tourist suggestion framework, together with a deployed VisualTourism system, to effectively target the challenges listed above has been developed. This system provides a method to exploit multimedia-oriented, geographically-related blog communities for representative data highlighting and personalized recommendations.

In an embodiment, when a target user uploads a photo album to a blog with location tags, the system can automatically suggest to the target user their best preferred cities, famous landmarks, and views for their tourism preferences by analyzing correlations of the target user's photographs with the blog community. Throughout the document, the terms “scene”, “view” and “landmark” shall have the following meanings. “Scene” includes but is not limited to a tourist site that a blog author has visited, photographed or otherwise discussed, such as the “Louvre Museum in Paris” and the “Pike Place Market in Seattle. “View” includes but is not limited to the place or viewpoint that photos are taken within the scene, for instance, the “Mona Lisa”, “Venus de Milo” and “Madonna” at the “Louvre Museum” scene in “Paris”. Each “Scene” includes but is not limited to several “Views” that represent different visual aspects and highlights from blog photos. “Landmark” represents a famous (e.g., a most famous) scene in a city, such as the “Louvre Museum”, the “Arc de Triomphe” and the “Eiffel Tower” in Paris, France.

The described system derives such functionalities fully automatically by mining blog community knowledge together with users' personal traveling albums. To address the location detection issue, geographically-related photos are identified from blogs or online journals offline and qualified photographs are crawled as the initial dataset. For data scale and noise issues, a bottom-up visual-textual hierarchical clustering is leveraged to distill the scene and view the structure from the un-organized photo dataset within each city. A PageRank photograph popularity evaluation algorithm to discover representative views within a scene is used to exploit community knowledge along with a landmark-HITS model for landmark discovery within cities. Finally, user similarity measurement is addressed by a collaborative filtering (CF) strategy for creating personalized recommendations online.

### Illustrative Architecture

FIG. 1 depicts an illustrative architecture 100 for discovering city landmarks from online journals (e.g., blogs, web pages, profiles, etc.) or other user-published content. As illustrated, the architecture 100 includes a computing device 102. The computing device 102 includes one or more processors 104 and memory 106. The memory 106 stores or otherwise has access to a location-based photo harvest component engine 110, a scene-view generation engine 112, a landmark discovery engine 114 and a personal recommendation engine 116 for providing personal suggestions of places to travel, points of interest and the like. The computer device 102 is connected to a network 1120 and a plurality of target users 122.

The computing device 102 may be employed offline in some instances for the activities related to the location-based photo harvest component engine 110, the scene view generation engine 112 and the landmark discovery engine 114. The activities related to the personalized recommendation engine 122 may be conducted online.

The architecture illustrated in memory 106 is also called the VisualTourism system. The VisualTourism system provides functionality to (1) identify and collect geographically related scene photos from blogs, (2) structuralize the unorganized photo dataset, (3) summarize the city photo set to find city landmarks, and (4) provide to blog users online recommendations for travel cities and landmarks that are determined to be the best fit for a particular blog user's interest. While the system may provide recommendations to blog users, it is to be appreciated that the system may also provide recommendations to email users, social networking users, or users of any other form of digital communication.

The component for the location-based photo harvest component engine 110 collects scene-related blog photos from online journals. Context-based geographic location identification is used to analyze whether a geographical reference belongs to a blog page. Once analyzed, the geographically related scene photographs and their contextual descriptors are harvested to form a scene dataset. Two kinds of blog photos may be harvested from blogs in some instances: 1) photographs within online journal articles, in which the nearest five lines of the surrounding contextual verbiage are stored as the context descriptors, and 2) photographs from photograph albums, for which the album title, photo title, and user comments are crawled as context descriptors. In some instances, user-applied tags may also be used as context descriptors. Geo-ambiguity is addressed by a gazetteer-based hierarchical comparison. Many other instances can be envisioned by this discussion. In general, various parameters can be used to identify context descriptor information to be stored and photograph identification information.

The scene-view generation engine 112 organizes the unstructured photo dataset for future processing. A hierarchical visual-textual clustering scheme is used to distill the scene-view structure from city photos.

The landmark discovery engine 114 provides a summary for city scenes and highlights city landmarks and their representative views from the city photo set. This component consists of both intra-scene view selection and inter-scene landmark discovery processes. In intra-scene view selection, the system selects dominant photographs as scene representations. The selection of the dominant photographs may: (1) reflect the consensus of online journal users, and/or (2) summarize a scene photo set to facilitate user navigation. The selection is achieved by a PhotoRank algorithm. In inter-scene landmark discovery, the system conducts the scene popularity evaluation as well as user correlation and popularity estimation. This scene popularity evaluation facilitates landmark summarization at the city level as well as community-based personalized tourist suggestions. A Landmark-Hypertext-Induced Topic Selection (HITS) popularity propagation model is used to integrate author, content, and context issues together in scene popularity and user correlation inference.

The personalized recommendation engine 122 offers online tourist suggestions or personalized recommendations when a target user uploads tourist photos into his online journal. The personalized recommendation suggests to a target user the most relevant cities and landmarks to which the target user may want to travel to, learn about, see pictures from, or any other similar use. The system may suggest such recommendations by analyzing correlations of the target user's tourist photos with the blog community. The recommendation results are visualized in a user interface in which landmarks are ranked and displayed in one portion of the display device, and the representative photos of each scene are placed in a larger, prominent location on the display device. The most popular landmarks within each city are geo-annotated on a satellite map to facilitate browsing by the target user.

### Illustrative Processes

FIG. 2 depicts an illustrative process 200 for implementing the VirtualTourism system that may be implemented by the architecture of FIG. 1 and/or by other architectures. The process 200 is described with reference to the location-based photo harvest component engine 202, the scene-view generation engine 204 and the landmark discovery engine 206.

The location-based photo harvest component engine 202 identifies whether a blog photograph relates to a certain city, and if so, to which city it belongs. In this step, only geographically related photographs and descriptors are extracted from blog pages. A location extraction algorithm is used to identify geographical locations of blog photographs using their related contexts. A gazetteer-based geographical location hierarchical identification algorithm is also used to identify geographical locations of blog photographs. In an embodiment, a pre-defined gazetteer is used to identify geographically located place name candidates and then the identified place name candidates are compared to establish a meaningful placename synonymy and placename polysemy.

The location-based photo harvest component engine 202 includes a user community 210. The user community posts photographs and descriptors 212 in an online journal. A location identification 214 operation is performed to identify relevant photographs using context descriptors and associated geographical references as discussed above.

The photo harvest 216 operation then extracts the relevant photographs along with the context descriptors which may include text. Text parsing 218 is conducted to identify similarities in the associated text. Meanwhile, the photographs harvested in operation 216 are used to create a photo database 220. A Scale Invariant Feature Transform (SIFT) feature extraction 222 is conducted to transform salient image regions into descriptors. The descriptors are then evaluated using a vocabulary tree indexing 224.

In the photo harvest process 216, in an embodiment, Windows® Live Spaces™ may be used as the source for blog content (http://spaces.live.com/). Live Spaces blogs that are described with city names or related geo-location names in the candidate city list are parsed to obtain the most confident location and its focus (no location results in 0 focus) from the related descriptors of each blog photo. Only the photos that are both within the candidate city list and have a high focus score are downloaded (together with their descriptors) into the scene photo set.

The near-duplicated visual clustering 226 in the scene-view generation engine 204 uses the vocabulary tree indexing information 224 to find the photographs that are duplicates or near duplicates. The identified photographs are clustered to keep the visually clustered photographs together. For a famous landmark, blog users usually take photos from several identical views, which are popular by user consensus and comprise a large portion of the photos belonging to this landmark. Exploiting this trend, near-duplicate visual clustering is adopted with a large cluster number for view generation, motivated by three purposes: (1) share context descriptors within near-duplicate photos, (2) model author relationships at view level, and (3) filter out insignificant photos belonging to unpopular views by discarding small clusters.

First, visual clustering with a large cluster number N is conducted, in which the similarity between Bag-of-Visual-Words vectors was calculated using Equation 2. Bag-of-Visual-Words is a term of art used in scene classification based on keypoints extracted as salient image patches. A Bag-of-Visual-Words representation is leveraged to discover content association between two photos as described above: The crawled photos are scanned offline to detect salient regions and transformed into descriptors. These descriptors are quantized by hierarchical k-means clustering to generate a vocabulary tree (VT), which produces “visual words” (quantized clusters with SIFT features) to represent each photo as a Bag-of-Visual-Words vector. A word's importance in the Bag-of-Visual-Words vector is evaluated by TF-IDF. The similarity of two images (i, j) is calculated using the cosine distance between their corresponding Bag-of-Visual-Words vectors (\vec{v}ᵢ, \vec{v}ⱼ):

$$Similarity ( i , j ) = \frac{{\vec{V}}_{i} \cdot {\vec{V}}_{j}}{\vert {\vec{V}}_{i} \vert \vert {\vec{V}}_{j} \vert} \qquad ( 1 )$$

The context information from the crawled content includes: Photo Title, Photo Album Title, Photo Description, Photo Comments (photo comments of other users), and Photo Surrounding Texts. Such contextual information is described using a triple element as: T={tᵢ|tᵢ={Dᵢ, Aᵢ, Fᵢ}}, in which tᵢ is the context of the i^{th} photo, containing: (1). Dᵢ: the date the photo was taken; (2) Aᵢ: the author ID of this photo, unified by a Hash list; (3) Fᵢ: the crawled context information. Consequently, the photos belonging to a certain author or certain description could be defined as Tₐ={tᵢ ε T|Aᵢ=α}, and T_{d}={tᵢ ε T|d ε Fᵢ}. Fᵢ is filtered using stop-word removal and then build a Bag-of-words document model for each descriptor Fᵢ. Using a Bag-of-Words description for the Fᵢ of each photo, two photos are associated if and only if they share one or more identical text words.

Second, the most similar clusters are aggregated based on inter-cluster similarity using Equation 2, in which Cᵢ, Cⱼ are the i^{th} and j^{th} clusters, p, q are photos within the corresponding clusters, Fₚ and F_{q} are Bag-of-Visual-Words features of photos p and q, and Cos (Fₚ, F_{q}) denotes the Cosine distance between Fₚ and F_{q}:

$$Similarity ( {C}_{i} , {C}_{j} ) = \frac{{\sum }_{p ∈ {C}_{i} , q ∈ {C}_{j}} Cos ( {F}_{p} , {F}_{q} )}{\vert {C}_{i} \vert \times \vert {C}_{j} \vert} \qquad ( 2 )$$

Once the similarity between two clusters is lower than a given threshold, these two clusters are merged into an identical cluster. The clusters with less than M photos are discarded from the photo dataset, because they are not part of the visual consensus of blog users.

In share textual descriptors 228, the information from near-duplicated visual clustering 226 is sent to share textual descriptors 228 along with textual descriptors sent from the test parsing operation 218. The textual descriptors 228 are then sent to textual clustering for view generation 230. This operation clusters the textual descriptors as opposed to the visual descriptors in near-duplicated visual clustering 226. Within each near-duplicate cluster, textual descriptors Fᵢ of each photo i are shared since their context similarity can reveal the contextual consensus. The ensemble of the Bag-of-Words vector is adopted as the context description of this view. Textual clustering is then adopted to aggregate views to produce scenes, which leverages tags of community consensus within different scenes to distinguish them.

To further improve textual clustering accuracy, a stop-word removal process is integrated for considering location issues. Adjectives and verbs are removed from the descriptors. Both traditional stop words (“a”, “the”) and location-specific stop words (city names and human names) are removed from the cluster's context representation.

The information from the near-duplicated visual clustering 226 operation is also sent to the within scenes operation 232 in the landmark discovery engine 206.

Based on the structured photo dataset, the city landmarks may be further summarized and highlighted. This process can be further parsed into two challenging tasks. First, typical photos may be selected to represent each scene, which is addressed by the proposed PhotoRank algorithm. Second, the scene popularity is evaluated for landmark summarization, which is addressed by the proposed landmark-HITS model.

A PhotoRank algorithm is used to discover representative photos within each scene by propagating photo popularities based on their context and content associations. This is an iterative popularity discovery strategy similar to PageRank. PageRank evaluates page importance by expecting important pages to be linked with other important pages. Analogously, PhotoRank also relies on the democratic community character within scene photo sets. Photographs associated with more visually similar photographs and/or co-described with more similar descriptors are more likely to represent city landmarks.

Users usually take photos of a scene from the most famous views and label these photos with the scene names. For instance, tourists in Beijing usually take photos from the front view of Tiananmen and label them as “Tiananmen”. This kind of photo comprises a large portion of blog photos that belong to a famous scene. They associate compactly with each other in either context or content descriptors. This consensus reflects the popularity of this view in representing the current scene. The associations in the Web community reflect the user majority consensus. Consequently, the photo significance may be evaluated within its scene by iterative popularity propagation.

Similar to the PageRank environment, photographs are viewed as analogous to pages, and context and content similarities are modeled as links. Scene photographs are associated with each other by content descriptors (Bag-of-Visual-Words) as well as contextual descriptors (Bag-of-Words). Two photographs are assigned a content or context link if two local patches (one from each photo) fall into the same word in the Bag-of-Visual-Words or Bag-of-Words vector respectively.

In photo popularity propagation, similar to the Page Graph definition in PageRank, a Photo Graph is constructed for popularity calculation. Assuming there are n blog photos in a city dataset, a Photo Graph is defined as an undirected graph with n nodes, each representing a photo. An n×n weight matrix W is further constructed to represent photo correlations. For non-diagonal positions, each node Wₚ(i,j) represents the correlation between the i^{th} and j^{th} photos and for the diagonal position, each node Wᵢ is the popularity of the i^{th} photo.

Initially, the popularity of each photo Wᵢ is assigned the uniformed value 1/n. The iteration rule of Photo Graph follows the principle of PageRank [12]:

$${W}_{i} = {\sum }_{j = 1 , j \neq i}^{n} \frac{{W}_{p} ( i , j )}{{c}_{j}^{i}} \times {W}_{j} \qquad ( 3 )$$

in which Wᵢ is the popularity of the i^{th} photo in Photo Graph, cⁱⱼ is the portion of links that the j^{th} photo given to the i^{th} photo normalized by the total links of the j^{th} photo (Σᵢ₌₁^{m} cⱼⁱ=1, in which the j^{th} photo is linked with a total of m photos in Photo Graph).

At each round, the weight of each photo is different. As a result, the weight of each photo contributed by other photos is also different. In Equation 2, the weight of the j^{th} photo is added as a current iteration to modify the contribution of the j^{th} photo to the weight of the i^{th} photo at the next iteration.

In each iteration, the popularity of each photo is updated using its linking associations with other photos based on their context and content similarity. The weights of all photographs are normalized after each iteration, satisfying the normalization restriction: Σᵢ₌₁ⁿ Wᵢ=1. This popularity estimation is conducted iteratively on the Photo Graph to discover and refine the popularity of each photo within the current scene.

To further integrate content and context information together into popularity ranking, a naïve Bayesian combination is adopted, in which the conditional independency assumption is made between content and context features as follows:

Wₚ(i,j)=W_{{c,t}}(i,j)=W_{c}(i,j)×Wₜ(i,j) (4)

in which Wₚ(i,j) is the overall similarity between the i^{th} and j^{th} photos; W_{c}(i,j) denotes the content similarity between the i^{th} and j^{th} photos; Wₜ(i,j) stands for the textual similarity between the i^{th} and j^{th} photos, which is based on the cosine distance of their Bag-of-Words vectors, with a gazetteer-based ambiguity elimination. These two factors are combined to generate overall photo correlations Wₚ(i,j).

Rather than viewing the content similarity between two photos by calculating their overlapped local patches, the importance of different local patches with different contributions in the similarity calculation is considered, depending on the significance of its quantized visual words in the SIFT feature space. For instance, the local patches that frequently appear in chaos-like regions are less likely to indicate strong association between two given photos and vice versa. The linking association of two photos is defined as the ensemble of the linking associations between their corresponding blocks. In this case, “block” represents the ensemble of local patches that are quantized into an identical visual word. Based on this block level linking representation, the content associations of two photos i and j are defined as:

W_{c}(i,j)=Σ_{b=1}^{B} W_{b}×B_{b}(i,j) (5)

in which b=1 to B represents the Block (visual word) number; B_{b}(i,j) is the similarity of the b^{th} block between the i^{th} and j^{th} photos, which is identical to the intersection in the b^{th} word between these two photos; W_{b} is the block (word) importance, proportional to the IDF value of this visual word in the Bag-of-Visual-Words representation.

The within scenes operation 232 includes the PhotoRank operation 234. In PhotoRank operation 234, the photographs are ranked within particular scenes to discover representative photographs within each scene by propagating photograph popularities based on their context and content associations. It is an iterative popularity discovery strategy as described above.

In a similar manner, the textual clustering for view generation 230 information is sent to an among scenes operation 236. The among scenes operation 236 operation includes a combined landmark-HITS 238 operation to identify landmarks within cities. Meanwhile, the within scenes operation 232 sends its PhotoRank 234 information to the among scenes 236 operation for use in the landmark-HITS model 238 to be used in conjunction with the PhotoRank 234 information. The landmark and representative views 240 result from the landmark-HITS operation 238. The landmark and representative views 240 are sent to a collaborative filtering operation 242 in the personalized recommendation engine 208. In addition, the user community 210 sends information to the collaborative filtering operation 242. The user community 210 information and the landmark and representative view 240 information is evaluated in a collaborative filtering 242 operation. The results of the collaborative filtering 242 operation are sent to a results output user interface 244 which is then sent to an individual target user 246. The collaborative filtering 242 operation results in the personalized recommendation and the result output user interface 244 puts the personalized recommendation in a user interface format easily readable or audible by the target user 246.

Based on city summaries (landmarks and representative views) and user significance (Landmark-HITS prediction), the system further achieves the personalized tourist recommendation for blog users who upload tourism logs (photos, descriptions) online to his blog.

Inferring author associations or correlations is important in creating a personalized tourist recommendation. The calculation of author correlation is by nature a hierarchical process. From the content aspect, two authors could visit the same city (city-level correlation), go to an identical scene (scene-level correlation), and photograph near-duplicate views (view-level correlation). From the context aspect, author's descriptions are may also be organized a hierarchical structure. The correlation analysis method integrated both issues within a hierarchical combination process, in which the city, scene, and view correlations are defined as in Equations 6-8 respectively:

$$\begin{matrix}A {C}_{i , j}^{City} = {\sum }_{k ∈ K} {w}_{k}^{City} \times ( {P}_{i}^{k} ⋀ {P}_{j}^{k} ) & ( 6 ) \\ A {C}_{i , j}^{Scene} = {\sum }_{k ∈ K} {w}_{k}^{Scene} \times ( {P}_{i}^{k} ⋀ {P}_{j}^{k} ) & ( 7 ) \\ A {C}_{i , j}^{View} = {\sum }_{k ∈ K} {w}_{k}^{View} \times ( {P}_{i}^{k} ⋀ {P}_{j}^{k} ) & ( 8 )\end{matrix}$$

in which AC_{i,j}^{City}, AC_{i,j}^{Scene}, and AC_{i,j}^{View} represents the associations of i^{th} and j^{th} authors at city, scene, and view levels respectively. Pᵢ^{k} denotes the portion of the i^{th} author's contribution to the k^{th} city/scene/view respectively. Wₖ^{City}, Wₖ^{Scene}, and Wₖ^{View} are the popularity of this city/scene/view respectively. Consequently, the following equation is used to evaluate the similarity between author i and j:

Sim(i,j)=α=AC_{i,j}^{view}×β×AC_{i,j}^{scene}+(1−α−β)AC_{i,j}^{city} (9)

Finally, the author associations are stored in an M×M matrix to facilitate the subsequent collaborative filtering process. Consider a new author A_{T} with personalized tourist log {T_{T}, C_{T}}, in which {T} is the set of textual descriptors and {C} is the set of photo contents. Generally speaking, the recommendation results of the target author A_{T} is determined by both the preferences of other users and the similarAity to the target user, as in Equation 10:

$${R}_{{A}_{T} , S} = \frac{1}{K} {\sum }_{i = 1}^{K} Sim ( {A}_{T} , {A}_{i} ) \times {\overline{R}}_{{A}_{i}} \qquad ( 10 )$$

in which R_{A}_{_{T}}_{,S} is the recommendation results for target author A_{T}; Sim(A_{T},Aᵢ) is the similarity between author A_{T} and the i^{th} author Aᵢ, which is calculated based on Equation 9, K is the total number of authors; and R̅_{A}_{ᵢ} is the tourist log of the i^{th} author.

To generate a recommendation, the former tourist log of the target user is leveraged together with tourist logs of other relevant users and their similarities to the target user to produce the personalized recommendation results. For the similarity measurement between two users, Sim(A_{T},Aᵢ) is defined as the user similarity in Equation 9. In particular, when the tourist photo album of the target user is missing, the prediction (Equation 10) would produce a generalized result from users' common sense of tourist preferences.

The updating of the similarity matrix for new user activities is a linear-cost process: When a new user uploads new tourist photos, the similarity matrix needs a row/column insertion process, in which 3K+1 linear calculations are demanded based on Equations 6-8. When an original user uploads additional tourist photos, the calculation updating process is also 3K+1, still linear to user volume.

FIG. 3 depicts an illustrative process 300 for extracting the location photographs in the location-based photo harvest component engine as described in FIG. 2. Operation 302 first finds a photo in a blog. The related content of the blog photo is then determined from the photo at operation 304.

To further improve textual clustering accuracy, a stop-word removal operation 306 is adopted to consider location issues. Considering location issues means that adjectives and verbs are removed from the descriptors. In other words, the stop words removal at operation 306 is utilized to filter out descriptors that are irrelevant for the photo context. In addition to traditional ‘stop words’ definitions, ‘stop words’ in this case also includes the words that are not location entities. A stop word list 308 may be generated from statistical data collected from any source. For instance, the LA Times (1994-1995) and Glasgow Herald (1995) newspapers may be used as sources. There are several rules for stop words refinement, for instance, (1) words frequently used with Mr. and Ms. e.g. “Neville” and (2) commonplace locations such as “Bus Station”, “Business Center”, and “Central Bus Station” are two examples. As stated earlier, in this manner, both traditional stop words (“a”, “the”) and location-specific stop words (city names and human names) may be removed from the cluster's context representation.

A location candidate is generated in operation 310 and occurs after the stop word removal operation 306. However, to identify whether the related contextual descriptors of a certain photo are a geographical place, a gazetteer is created at operation 312. In the gazetteer construction, various geographic information sources are collected, including zip codes, telephone numbers and geographic names. To identify the geo-locations of candidate words, a hierarchical geographic identity table with child-parent relations such as “New York→Brooklyn” and “Seattle→Redmond” (covering more than 1,000 main cities from all over the world) is developed for word matching. To further improve the gazetteer, historical and organizational issues were considered, such as “Korea”, “Former Eastern Bloc”, “Former Yugoslavia” and “Middle East”. Such words are mapped to location identities (e.g. Korea=South Korea+North Korea) to enhance matching recalls. As discussed earlier, U.S. patent application Ser. No. 11/081,014 provides a more complete location extraction discussion.

To find all candidates from the contextual descriptors of each photo that appear in the gazetteer, the longest-match principle is utilized. For example: if “New York” and “York” are both detected in an article, on the basis of the longest-match principle only “New York” is identified as a location candidate.

The gazetteer is used to identify location candidates. In operation 314, the identified location candidates are evaluated to determine whether they are related geographically with other photographs. If the answer is no, that particular photograph is discarded in operation 316. If the answer is yes, the process continues to a hierarchical geo-disambiguation of operation 318. Again the gazetteer information is utilized in the hierarchical geo-disambiguation.

In the location identification step, there are many different locations that have the same name, and there are some names which are not used as locations (such as person names). A rule-based approach is employed to disambiguate the candidates in the hierarchical geo-disambiguation 318 operation. Based on the location hierarchy definition of the gazetteer, the geo-ambiguity of location candidates is eliminated using a Hierarchical-comparison based Geo-Disambiguate (HGD) algorithm:

Based on the pre-defined hierarchical location relationships in the gazetteer, the city-level location of a blog photo is determined using the combination of its lower level locations. For instance, there are usually two or more city names with an identical descriptor, such as “Cambridge” in Massachusetts and “Cambridge” in England, United Kingdom. If “MIT” is included in this descriptor, it can be inferred that the term “MIT” belongs to “Cambridge” in Massachusetts with a higher probability.

Formalizing this solution, the candidate locations are mapped onto a location hierarchy. The candidate locations introduce a concept called “focus” to eliminate the geo-ambiguity of location candidates. For each location candidate l, its focus is calculated by Equation 11, in which f_{c}(l) is the sum of the confidences of l in the descriptor:

focus(l)=f_{c}(l)+αΣₗ_{ᵢ}_{εoffspring(l)}focus(lᵢ) (11)

The focus of a certain location consists of two parts. The first part is from itself if it is mentioned in the article. The second part is from its offspring (propagation with a decay factor α). Thus, even if the location l is not explicitly mentioned in the descriptor, the descriptor may also have focused on l. For example, a photo titled with “Redmond” would be also included in the term “Seattle”.

A city identification operation 320 uses the information from the hierarchical geo-disambiguation operation 318 to identify cities. Operation 322 then determines if the identified cities are within a particular city list. If the answer is no, that particular photograph is discarded in operation 324. If the answer is yes, the photograph is harvested in operation 326. This is the same photo harvest operation 216 in FIG. 2.

FIG. 4 depicts the longest matching principle used in the location candidate generation operation 310 in FIG. 3. The principle is shown by using an example. Example 402 states “Mary works in New York and she is a journalist.” The words “New York and” are contained in the representative statement in example 402 and are identified individually as “New” in operation 404, “York” in operation 406, and “and” in operation 412. The word “York” is identified as a location candidate for “York” in operation 408 and the words “New” and “York” are both identified as location candidates for the term “New York” in operation 410. The longest matching principle finds the matching by approaching the problem from two different aspects. In operation 414, “York” is classified as a location. Meanwhile, operation 418 finds that “New York and” is not a location and “New York” is a location. By combining operations 414 and 418, operation 416 finds that “New York” is a match and “York” is disregarded. This matching principle is used to find locations in blog text.

FIG. 5 represents the scene-view relationship for organizing photographs for implementation in the architecture of FIG. 1. Photo datasets are structuralized by organizing photos into a scene-view structure. Operation 502 identifies a city. In the illustration, the city is identified as Beijing, however, any city may be identified and Beijing is used strictly as an example. Operations 504, 506, 508, 510, 512 and 514 represent different scenes in Beijing. Specific examples are shown on FIG. 5 for illustration purposes only. The important point to note is that for any given city identified in an online journal, there are many different scenes associated with that city. In the illustration at hand, several scenes from Beijing are identified, including Tsinghua University, Summer Palace, Lama Temple, Tiananmen, Temple of Heaven and Forbidden City represented by the circles identified as S1 through S5 respectively. Finally, one of the scenes is chosen. In the example in FIG. 5, operation 510 representing Tiananmen is illustrated. Users 516, 518 and 520 have posted different scenes that are identified as matching to scene 510. Operations 522 through 534 correspond to views V1 through V7. Views V1 through V 7 represent the views identified on the online journals that relate to the scene S4 in operation 510 represented by Tiananmen.

FIG. 6 illustrates the landmark-HITS model used in the implementation of the architecture in FIG. 1. To summarize city landmarks from scene photos, a Landmark-HITS model is described to evaluate scene popularity by integrating author information in popularity inference. The proposed Landmark-HITS model is a three-layer semi-supervised reinforcement model in scene popularity inference.

The photo layer or photo nodes 606 is the lowest layer, in which each node represents a photo. The value of each node (P1 through P7) represents the popularity of this photo within this scene, which is derived from the PhotoRank algorithm. The scene layer or scene nodes 604 is the ensemble of photo nodes 606 from textual clustering, in which the value of each node (S1 and S2) represents its popularity within the current city. The author layer or author nodes 602 is the blog author (A1, A2 and A3) that contributed photos to the city photo dataset. The value of each node in this layer corresponds to its popularity as discussed below.

Each author node Aᵢ represents an author of a web blog, similar to Hub nodes in HITS. Each scene node Sᵢ represents the ensemble scene; each photo node Vᵢ represents a photo within each scene, both scene and photo nodes are similar to authority nodes in HITS. Author-identical photos are associated with the same author node. The photo link represents the association of two photos as depicted by the dashed lines connecting various combinations of the photo nodes 606 with each other.

The authority link of an author and its scenes/photos is for populating popularity scores in a HITS-like semi-supervised learning manner, in which three kinds of popularity propagations are conducted sequentially to infer node popularity in an iterative style:

(1). Authority Aggregation from Photo to Author: In each iteration, the popularity of an author node 602 is updated using the popularity of photos belonging to this node, which are pre-computed by PhotoRank iteration. The updating rule for author node Aᵢ is as:

$${A}_{i} = \frac{1}{K} {\sum }_{k = 1}^{K} \{ {w}_{k} \vert {Author}_{k} = i \} \qquad ( 12 )$$

in which Authorₖ is the author index of the k^{th} photo; k=1 to K means the photos that belong to the i^{th} author (subject to Authorₖ=i), and wₖ is the popularity weight of the k^{th} photo. The popularity score of the i^{th} author is updated using photos from this author after each round of PhotoRank popularity propagation. Hence within the user community, the author's popularity is measured based on whether or not they could contribute photos that are within common scenes of other users.

(2). Popularity Propagation from Author to Scene: Following the democratic voting nature of users, the popularity of each scene 604 is derived from the popularities of authors that contribute photos to this scene. Scene 604 that is contributed by more authors is more likely to be a representative landmark. Scene popularity is updated by Equation 13:

$${W}_{m} = \frac{1}{{N}_{m}} {\sum }_{k ∈ I} ( {A}_{i} \times \frac{{\sum }_{k = 1}^{K} \{ {w}_{k} \vert {Author}_{k} = i \& {Scene}_{k} = m \}}{{\sum }_{k = 1}^{K} \{ {w}_{k} \vert {Scene}_{k} = m \}} ) \qquad ( 13 )$$

in which m is the m^{th} scene; Nₘ is the number of photos within this scene, Aᵢ is the i^{th} author (totally I); w^{k} is the photo popularity of the k^{th} image; and the restriction in the inner summating of Equation 13 means that the weight of photos belonging to the i^{th} author and the m^{th} scene are combined, proportional to the i^{th} author's contribution of the m^{th} scene. Based on Equation 13, the popularity of author node Aᵢ is propagated to its scene nodes to update its weight W.

(3). Integrate Author Popularity to Refine PhotoRank: Based on the inferred author popularity, the photo popularity within each scene may be further updated in a reinforcement manner. The weight of each photo is modified before the next-round of PhotoRank iteration:

wₖ^{initial}^{^{t}}=wₖ^{final}^{^{t−1}}×{Aᵢ|Authorₖ=i} (14)

in which wₖ^{initial}^{^{t}} is the initial weight before the i^{th} PhotoRank iteration, wₖ^{final}^{^{t−1}} is the final weight after the (t−1)^{th} PhotoRank iteration, and Aᵢ is the author that this k^{th} photo belongs to. Using Equation 14, the PhotoRank procedure is embedded into the iteration procedure of the Landmark-HITS model. Its motivation is similar to HITS: The “sophisticated author” with better photographic ability contributes more to the significance of photos, and vice versa.

By popularity updating, the algorithm summarizes the city scenes and highlights the most representative city landmarks while filtering out unpopular scenes.

FIG. 7 depicts an illustrative process for discovering city landmarks from online journals. In process 700, photographs are identified from various online journals in operation 702. Operation 704 extracts the identified photographs from the online journals. The photographs are organized into a clustering of views in operation 706 and the views are ranked in a hierarchical order in operation 708. The author and content information associated with the views are modeled in operation 710. Using the author/content information modeling results, author correlations are created in operation 712. The author correlations and the organized photographs are filtered in operation 714 and a personalized recommendation is provided to a target user from the filtering results in operation 716.

### CONCLUSION

The wealth of community-contributed multimedia offers a novel opportunity to mine interesting insights, which demands specialized algorithms for analyzing its unique nature. While state-of-the-art methodologies address content understanding and community analysis in a loosely coupled manner, the system presented seamlessly integrates the exploration of both issues into methodology design as a unified framework. A blog-based city landmark discovery framework is presented to discover and summarize popular scenes and their representative views from blog photos for online personalized tourist suggestions. The methodology described herein serves as an example for knowledge extraction from such data and can also be transferred into other application domains for community multimedia interpretation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable media storing computer-executable instructions that, when executed on one or more processors, perform acts comprising:
identifying one or more photographs from a plurality of online journals;
clustering the one or more photographs into one or more views from which the one or more photographs have been captured;
modeling author, context and content information associated with the one or more views to discover one or more representative photographs and build author correlations;
filtering the author correlations and the one or more representative photographs; and
providing personalized recommendations to a user based at least in part on the filtering of the author correlations and the one or more representative photographs.

2. The one or more computer-readable media according to claim 1, wherein the one or more photographs contain one or more contextual descriptors, the one or more contextual descriptors used to create one or more geographical associations with the one or more photographs.

3. The one or more computer-readable media according to claim 2, wherein the context information includes the one or more geographical associations, title information, and user comments entered in the online journals.

4. The one or more computer-readable media according to claim 1, wherein identifying the one or more photographs from a plurality of online journals comprises analyzing a gazetteer to identify at least a portion of the one or more photographs.

5. The one or more computer-readable media according to claim 1, wherein the modeling includes an iterative discovery process used to discover the one or more representative photographs that are significant with respect to the author and context information.

6. The one or more computer-readable media according to claim 1, wherein the filtering is a collaborative filtering using preferences from a plurality of users and a target user.

7. One or more computer-readable media storing computer-executable instructions that, when executed on one or more processors, perform acts comprising:
identifying one or more photographs from a plurality of online journals;
storing the identified one or more photographs in a database;
clustering the one or more photographs into one or more views and into one or more textual descriptions;
modeling author, context and content information associated with the one or more views and the one or more textual descriptions to discover one or more representative photographs and create one or more author correlations; and
collaboratively filtering the one or more author correlations and the one or more representative photographs to provide a personalized recommendation to a user.

8. The one or more computer-readable media according to claim 7, wherein the correlations are filtered to determine relevant photographs from the one or more representative photographs provided for the personalized recommendation.

9. The one or more computer-readable media according to claim 8, wherein the filtered correlations use a collaborative filtering that combines preferences from a plurality of users and a target user.

10. The one or more computer-readable media according to claim 7, wherein the one or more photographs contain one or more contextual descriptors, the one or more contextual descriptors used to create one or more geographical associations with the one or more photographs.

11. The one or more computer-readable media according to claim 10, wherein the content information includes the one or more geographical associations, title information, and user comments entered in the online journals.

12. The one or more computer-readable media according to claim 7, wherein identifying the one or more photographs from a plurality of online journals comprises analyzing a gazetteer to identify at least a portion of the one or more photographs.

13. The one or more computer-readable media according to claim 7, wherein the modeling includes an iterative discovery process used to discover the one or more representative photographs that are within a scene by propagating photograph popularities based on the one or more author correlations.

14. The one or more computer-readable media according to claim 9, wherein the modeling includes an iterative discovery process used to discover the one or more representative photographs that are significant with respect to the author, context and content information.

15. A method for discovering one or more photographs from a plurality of online journals for providing a personalized recommendation comprising:
extracting the one or more photographs from the plurality of online journals;
storing the extracted one or more photographs in a database;
clustering the one or more photographs into one or more views and one or more textual descriptions;
modeling author, context and content information associated with the one or more views and the one or more textual descriptions to discover one or more representative photographs;
creating one or more correlations between an author, the one or more representative photographs and the one or more textual descriptions; and
providing a personal recommendation based at least in part on the created correlations.

16. The method according to claim 15, wherein. creating correlations further comprises conducting a filtering operation to define one or more relevant correlations.

17. The method according to claim 16, wherein the one or more relevant correlations are utilized at least in part to create the personal recommendation.

18. The method according to claim 15, wherein the one or more photographs contain one or more contextual descriptors, the one or more contextual descriptors used to create one or more geographical associations with the one or more photographs.

19. The method according to claim 18, wherein the content information includes the one or more geographical associations, title information, and user comments entered in the online journals.

20. The method according to claim 15, wherein identifying the one or more photographs from a plurality of online journals comprises analyzing a gazetteer to identify at least a portion of the one or more photographs.
